(19) United States
(12) Patent Application Publication
(10) Pub. No.: US 2002/0074801 A1
(43) Pub. Date: Jun. 20, 2002

(54) Elbow connection

(76) Inventors: Anthony K. Chan, Peoria, IL (US); Shaun M. Copley, Lafayette, IN (US)

Correspondence Address: McGUIREWOODS LLP, ATTN: Andrew M. Calderon, 1750 TYSON BLVD, SUITE 1800, McLEAN, VA, 22102, US

(21) Appl. No.: 09/742,718

(22) Filed: Dec. 20, 2000

(51) Int. Cl. F16L 23/00

(52) U.S. Cl. 285/415

(57) ABSTRACT

An elbow connection having coupling members for connecting between components of an internal combustion engine. The elbow connection has a reduced curvature and maintains a proper connection between the components of the internal combustion engine. The elbow connection includes a first end and a second end. A flange is formed near the first end and an o-ring groove is formed between the first end and the flange. A female coupling member is formed at the second end.

### TECHNICAL FIELD

This invention relates generally to an elbow connection and more particularly to an elbow connection having coupling members.

### BACKGROUND ART

Internal combustion engines include many subsystems having a vast array of mechanical components which need to be mechanically interconnected in order for the internal combustion engine to work in its intended manner. These subsystems may include coolant systems, exhaust systems, fuel injection systems and the like. In a coolant system, for example, an after cooler or heat exchanger is interconnected by tubes to the engine block so that fluid can pass between the heat exchanger and the engine block.

The tubes associated with the coolant system as well as other subsystems of the internal combustion engine include ends which have double upsets. The formation of the double upsets includes fashioning two adjacent bumps at the ends of the tubes so that gaskets or o-rings can be fitted therebetween. The fitted gaskets or o-rings ensures a proper seal between adjacent tubes or between the heat exchanger and the engine block of the internal combustion engine. However, the formation of the double upsets increases the manufacturing time and costs associated with the production of the tubes.

Conventional tubes also require retaining clips for fastening the tubes to adjacent tubes or respective components of the internal combustion engine. These retaining clips may be spring loaded clips or conventional clamp type clips. It is noted that these retaining clips do not always provide the necessary force to maintain the connection between the adjacent tubes or respective components, and have a tendency to fail after extensive use.

In many internal combustion engines the tubes must also be bent to form elbow connections. This allows the tubes to fit within the engine compartment and connect the respective components. To bend the tubes, it is necessary to maintain a minimum straight length prior to the bend so as to maintain a minimum strength of the tube, and especially at the ends of the tubes. This minimum straight length is typically in the range of 85 mm or more with a 6.4 cm (2.5 inches) diameter tube. This minimum straight length thus increases the radius of curvature of the elbow connection which, in turn, increases the space needed within the engine compartment to accommodate the elbow connection. Also, it is difficult to maintain the positional tolerances (e.g., straight approach) between the centerlines of the elbow connection and adjacent tubes or the openings of the respective components in which the tubes connect thereto. This is mainly due to the fact that it is difficult to determine and maintain the proper beginning location for the bend.

The present invention is directed to overcoming one or more of the problems as set forth above.

Disclosure of the Invention

In one aspect of the present invention, an elbow connection has a first end and a second end. A flange is formed near the first end and an o-ring groove is formed between the first end and the flange. A female coupling member is formed at the second end of the tube.

In another aspect of the present invention, a connecting member has a first end and a second end. A flange is formed near the first end and an o-ring groove is formed between the first end and the flange. An upset o-ring receiver is formed on the second end of the tube.

In still another aspect of the present invention, an internal combustion engine includes an engine block and a heat exchanger. A connecting tube connects between the engine block and the heat exchanger by first and second elbow connections. The elbow connections have a first end and a second end. A flange is formed near the first end, and an o-ring groove is formed between the first end and the flange. A female upset o-ring receiver is formed at the second end of the tube.

### BRIEF DESCRIPTION OF THE DRAWINGS

FIG. 1 shows a diagrammatic front perspective view of an embodiment of an elbow connection of the present invention;

FIG. 2 shows a diagrammatic front perspective view of an embodiment of an elbow connection of the present invention; and

FIG. 3 shows a diagrammatic side view of an internal combustion engine adapted to use the elbow connection of the present invention.

### BEST MODE FOR CARRYING OUT THE INVENTION

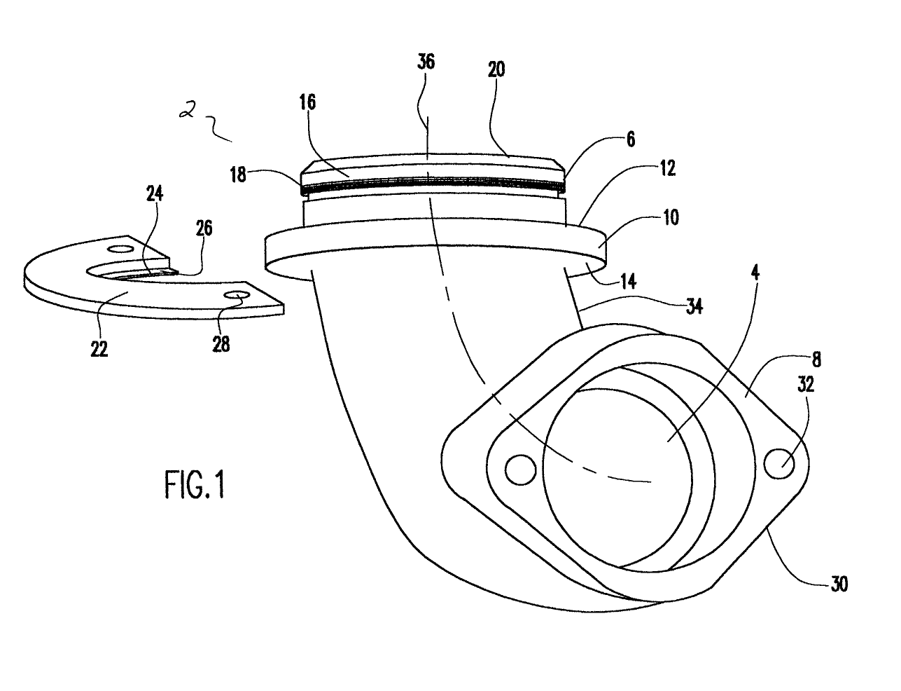

FIG. 1 shows an elbow connection generally depicted as reference numeral 2. The elbow connection 2 has a hollow interior portion 4, as well as a first end 6 and a second end 8. The hollow interior portion 4 is preferably cylindrical and has diameter of approximately 5 cm (2 inches). It is noted that the diameter provided herein is for illustrative purposes and that other diameter tubing such as a 1.25 cm (½ inch) diameter tubing may also be used with the present invention.

A flange 10 is located near the first end 6 and includes an upper mounting surface 12 and an opposing surface 14. In the preferred embodiment, the flange 10 is an integrally formed component of the elbow connection 2 and is provided as a coupling member. An o-ring groove 16 is formed between the first end 6 and the upper mounting surface 12 of the flange 10. An o-ring 18 may be placed within the o-ring groove 16. A tapered edge 20 may also be provided at the first end 6, but is not critical to the practicing of the present invention.

At least one retainer 22 is provided about the flange 10. The retainer 22 has an arc 24 which corresponds substantially to the shape of the flange 10. The retainer 22 further includes a recessed portion 26 which mates with the opposing surface 14 of the flange 10. Non-threaded bolt holes 28 are provided in the retainer 22. A female coupling member 30 is provided at the second end 8 of the elbow connection 2 and includes threaded bolt holes 32. The female coupling member may be a female upset o-ring receiver.

The elbow connection 2 may include a bend 34 located between the flange 10 and the female upset o-ring receiver 30. The bend 34 preferably has a compact radius of curvature; that is, the bend 34 may have a radius of curvature of 85 mm from a center line 36 of the elbow connection 2 when the diameter of the tubing is approximately 5 cm (2 inches). The bend also begins at approximately 18 mm from the upper mounting surface 12 of the flange 10 (e.g., straight length) when the diameter of the tubing is approximately 5 cm. It should be noted that other compact bend radii and straight lengths are also contemplated by the present invention, and that the elbow connection 2 may also be straight or have other curves.

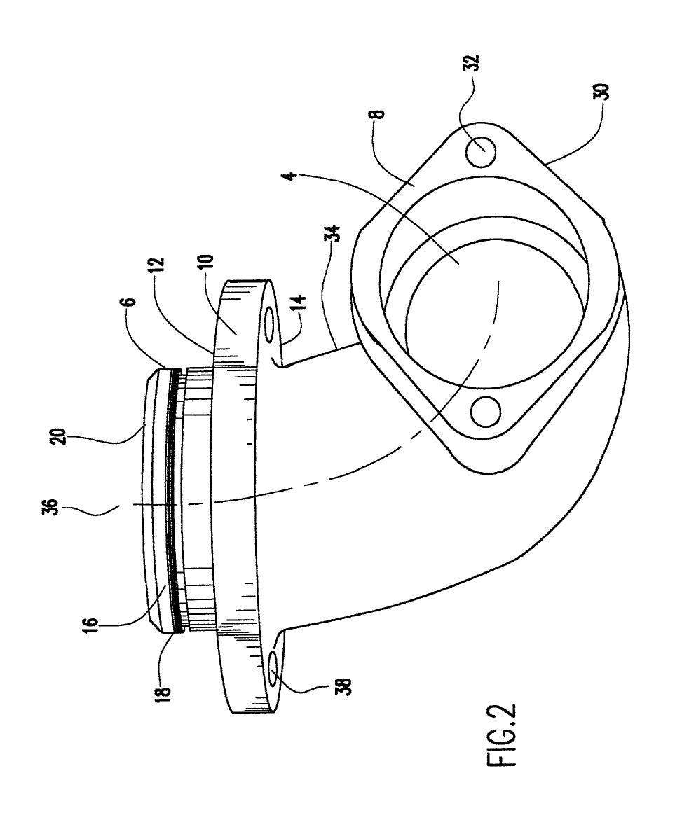

FIG. 2 shows an embodiment of the elbow connection 2 of the present invention. In FIG. 2, the flange 10 includes flange bolt holes 38 which eliminate the need for the retainer 20 (as shown in FIG. 1). The flange 10 also includes the upper mounting surface 12. The remaining features of the embodiment of FIG. 2 are identical to the features shown in FIG. 1 and are not discussed herein.

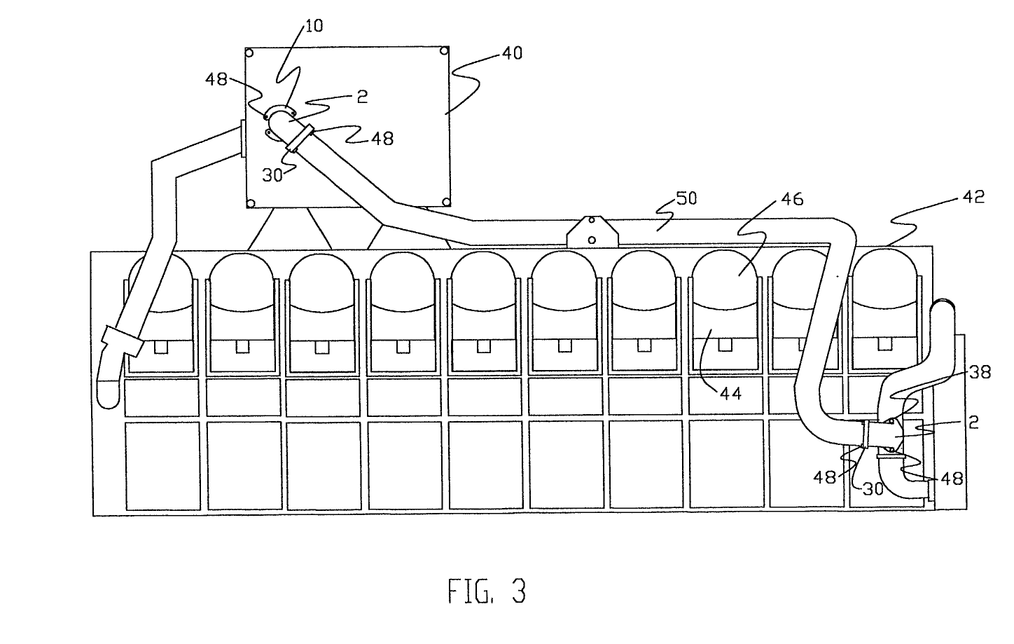

FIG. 3 shows a diagrammatic side view of an internal combustion engine adapted to use the elbow connection 2 of the present invention. The elbow connection 2 of FIG. 1 is connected to an after cooler or heat exchanger 40, and the elbow connection 2 of FIG. 2 is connected to an engine block 42. The engine block 42 houses cylinders 44, heads 46 and other internal components. The retainer 22 shown in FIG. 1 is mated to the flange 10 and bolted to the heat exchanger 40 via bolts 48. In this manner, the elbow connection 2 of FIG. 1 is mounted to the heat exchanger 40.

Similarly, the flange 10 having the threaded bolts holes 32 (FIG. 2) is mounted to the engine block 42 via the bolts 48. In this manner, the elbow connection 2 of FIG. 2 is mounted to the engine block 42. A second tubing 50 connects the respective female upset o-ring receivers 30 of the elbow connections 2 of FIG. 1 and FIG. 2 to one another via the bolts 48. The second tubing 50 may include the flange 10 and o-ring groove 16 arrangement of FIG. 1 or FIG. 2.

Industrial Applicability

In use, the elbow connection 2 of the present invention is mounted to the heat exchanger 40 and the engine block 42. On the heat exchanger 40 connection, the o-ring 18 is fitted within the o-ring groove 16 and the first end 6 is then inserted within the heat exchanger 40. At this stage, the upper mounting surface 12 of the flange 12 is flush with the surface of the heat exchanger 40. The retainers 22 are then placed about the opposing surface 14 of the flange 10 such that the recessed portions 26 are mated to the opposing surface 14 of the flange 10. The bolt holes 28 are then aligned with threaded bolts holes on the heat exchanger 40, and the bolts 48 are then fastened by a predetermined torque to the heat exchanger 40. The elbow connection 2 is now firmly mounted to the a heat exchanger 40 and is prevented from any axial movement. The elbow connection 2 also has a 360 degree range of motion (e.g., the elbow connection 2 can be turned at any orientation prior to the bolts 48 being fastened to the heat exchanger 40) and has a proper axial alignment between the centerline 36 of the elbow connection and the opening of the heat exchanger.

Another elbow connection 2 is then mounted to the engine block 42. In this example, the flange bolts holes 36 (of the elbow connection 2 of FIG. 2) are aligned with threaded bolts holes on the engine block 42. The bolts 48 are then fastened by a predetermined torque to the engine block 42. The elbow connection 2 is then firmly mounted to the engine block 42 and is prevented from any axial movement. The elbow connection 2 having the retainers 22 may equally be mounted to the engine block 42 in the manner described above.

A second tubing 50 is then mounted between the respective female upset o-ring receivers 20 via the bolts 48. More specifically, the ends of the second tubing 50 are provided with o-rings and then inserted within the respective female upset o-ring receivers 20. The bolts 48 are then used to clamp the second tubing 50 to the respective female upset o-ring receivers 20. The second tubing 50 may have the same couplings shown in FIG. 1 or FIG. 2.

In this manner, the elbow connections 2 of the present invention are in proper axial alignment with the openings of the heat exchanger 40 and the engine block 42 as well as the ends of the second tubing 50. The elbow connections 2 also maintain a secure connection between the heat exchanger 40 and the engine block 42 as well as the ends of the second tubing 50, and allows the passage of coolant between the heat exchanger 40 and the engine block 42 in order to cool gases within the heat exchanger 40.

Other aspects and features of the present invention can be obtained from a study of the drawings, the disclosure, and the appended claims.

1. An elbow connection, comprising:
a tube having a first end and a second end;
a flange formed near the first end of the tube;
an o-ring groove formed between the first end and the flange; and
a female coupling member formed at the second end of the tube.

2. The elbow connection of claim 1, wherein the flange includes an upper mounting surface.

3. The elbow connection of claim 1, including a retainer, the retainer mating with the flange.

4. The elbow connection of claim 1, wherein the retainer includes a recessed portion and the flange includes an upper mounting surface and an opposing surface, the recessed portion mating with the opposing surface.

5. The elbow connection of claim 4, wherein the retainer includes bolt holes.

6. The elbow connection of claim 1, wherein the female coupling member is an upset o-ring receiver.

7. The elbow connection of claim 1, wherein the flange includes bolt holes.

8. The elbow connection of claim 1, wherein the tube includes a hollow interior portion having a cylindrical cross section.

9. The elbow connection of claim 1, wherein the flange is integrally formed with the tube.

10. The elbow connection of claim 1, wherein the female coupling member includes threaded bolt holes.

11. The elbow connection of claim 1, wherein the tube includes a bend positioned between the flange and the female coupling member.

12. The elbow connection of claim 11, wherein the bend includes a radius of curvature of approximately 85 mm.

13. A connection member, comprising:
a tube having a first end, a second end and a hollow interior portion;
a flange integrally formed with the tube near the first end;
an o-ring groove formed with the tube between the first end and the flange; and
an upset o-ring receiver integrally formed on the second end of the tube.

14. The connection member of claim 13, including a retainer mating with the flange.

15. The connection member of claim 14, wherein the retainer includes a recessed portion and non-threaded bolt holes, the recessed portion mating with the flange.

17. The connection member of claim 13, wherein the flange and the upset o-ring receiver include bolt holes.

18. An internal combustion engine, comprising:
an engine block;
a heat exchanger;
a connecting tube having a first end and a second end;
a first elbow connection connecting the first end of the connecting tube to the heat exchanger; and
a second elbow connection connecting the second end of the connecting tube to the engine block;
wherein the first and second elbow connections include:
a tube having a first end and a second end;
a flange formed near the first end of the tube;
an o-ring groove formed between the first end and the flange; and
a female upset o-ring receiver formed at the second end of the tube.

19. The internal combustion engine of claim 18, wherein the female upset o-ring receiver of the first elbow connection is connected to the first end of the connecting tube, and the first elbow connection includes a retainer having a recessed portion which mates with the flange, the retainer includes bolt holes which are adapted for receiving bolts, the retainer and the flange are mounted to the heat exchanger.

20. The internal combustion engine of claim 18, wherein the female upset o-ring receiver of the second elbow connection is connected to the second end of the connecting tube and the flange of the second elbow connection is mounted to the engine block.
